(19) United States
(12) Patent Application Publication
(10) Pub. No.: US 2009/0045216 A1
(43) Pub. Date: Feb. 19, 2009

(54) Portable fluid-storage container and method of use thereof

(76) Inventor: Mark Mamaghani, Marietta, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 12/082,567

(22) Filed: Apr. 11, 2008

Related U.S. Application Data
(60) Provisional application No. 60/964,853, filed on Aug. 15, 2007.

(51) Int. Cl. B67D 5/58; B65D 88/54; B67D 5/40; G01F 11/10; B67D 5/60

(52) U.S. Cl. 222/1; 222/318; 222/189.06; 222/372; 222/143

(57) ABSTRACT

A portable fluid-storage container is disclosed that allows for a selected material to be stored and dispensed at a location where the fluid is needed. The portable fluid-storage container may further condition the fluid to ensure proper characteristics even after prolonged periods of storage, preferably with reduced waste.

### RELATED APPLICATION

The present United States patent application is related to, and hereby claims priority to and the full benefit of, U.S. Provisional application entitled “Portable Fluid-Storage Container and Method of Use Thereof”, filed 15 Aug. 2007 on behalf of Mark Mamaghani, and having assigned Ser. No. 60/964,853.

### TECHNICAL FIELD

The present invention relates generally to material handling, and more particularly to a portable fluid-storage container.

### BACKGROUND OF THE INVENTION

Fluids of various kinds, adapted for various uses, are needed in many places, such as on construction sites, on sea-going vessels, and in factories, among others. Typically, in-ground or other permanent storage devices have been provided at locations where fluids are needed repeatedly, or on a regular basis. Where portability is required, or where a fluid may be needed for only a single use or for a short duration, rudimentary storage tanks have been employed, consisting of simple refillable containers.

Extraction or dispensing of the fluid may be accomplished via a spout or other gravity-based method, or by attachment of a separate pump. When gravity-based methods are used, elevation of the container is required, which may not be practical, especially for larger containers, and may not provide sufficient force to dispense the fluid at a desired rate or pressure. While attaching a separate pump may overcome these disadvantages, other disadvantages are encountered, including the need to prime the pump, loss of the fluid, and contamination of the fluid.

Such simple containers further fail to enable adequate conditioning of the fluid, such as filtration, re-circulation, mixing, or the like. One or more of such conditioning processes may be critical to the proper use of the fluid, such as when the fluid comprises a mixture, such as a fuel and oil mixture, an emulsion, a pharmaceutical compound or chemical reagent, a food item, a lubricant, or the like. In order to address conditioning needs, separate conditioning devices and processes must be used, including further risks of loss or contamination of the fluid, or the like, in addition to the added cost associated with time and effort of attaching, maintaining, and operating the separate devices. The lack of such conditioning capabilities further requires pre-mixture of all fluids stored in the simple containers, which may limit a batch size and add cost to the fluid, while requiring reliance on the proper mixture of the fluid, since no correction may be made at the location where the fluid is needed.

As such, it is clear that there is an unmet need for a system and method for transportation, storage, conditioning, and dispensing of a fluid, whereby the fluid may be transported to a site where it is needed, stored until a time when the fluid is needed, and conditioned to achieve or maintain proper characteristics of the fluid.

### BRIEF SUMMARY OF THE INVENTION

Briefly described, in a preferred embodiment, the present invention overcomes the above-mentioned disadvantages and meets the recognized need for such a system and method by providing a portable fluid-storage container and a method of use thereof.

According to its major aspects, and broadly stated, the portable fluid-storage container includes a hermetically sealed body, including a prime mover for creating fluid flow and one or more integrated conditioning device(s), whereby one or more selected fluid(s) may be introduced into the container, transported to a desired location, stored, conditioned, and/or dispensed via the prime mover.

More specifically, the hermetically sealed body may be a body formed of metal, plastic, rubber, combinations thereof, or the like, defining an enclosed space, and may include one or more operable access port, whereby one or more fluid may be introduced into and contained within the enclosed space. The prime mover may be formed as one or more pump(s) operable with at least one access port, whereby fluid may be dispensed from the container. The hermetically sealed body may include one or more inert or resistant liner(s) adapted to contain a selected fluid without contamination, breakdown, or other undesired effect on the fluid, and without corrosion or other undesired effect on the hermetically sealed body.

A frame or housing may be included to protect the hermetically sealed body, and/or to provide additional functionality thereto, such as leveling, stacking, portage, or the like. The frame or housing may include a plurality of feet, which may be independently adjustable to enable a leveling feature, and which are preferably adapted to securely engage a top of a second container housing, whereby two or more containers may be stacked. The frame or housing preferably further includes means for engaging forks of a fork-lift, or other means, such as a hook of a hoist, crane, or lift, whereby the container may conveniently be carried and arranged in a desired location.

One or more filter(s), operable with the prime mover, may be included, whereby the fluid may be filtered by flow through the filter. The filter may preferably be selected to sufficiently condition the fluid, such as via removal of contaminants, undesired particulates, or the like, with a single pass through the filter. Alternatively, the filter may be selected such that multiple passes through the filter are performed in order to condition the fluid, in which case at least one return line and one or more flow control device(s), such as a valve or the like, may be included. Thus, the flow control device(s) may be actuated to allow fluid to re-circulate within the hermetically sealed body until a desired amount of conditioning, such as purification, has been achieved. The flow control device(s) may then be adjusted to allow the conditioned fluid to be dispensed.

A mixing device may further be included with a re-circulation feature, as described above, with or without filtration. For example, a static mixer, in the form of one or more nozzle, baffle, fin, or the like, may be disposed within a re-circulation flow, such as a flow driven by the prime mover, to produce turbulence or other flow within the fluid, whereby mixing of the fluid, or two or more components thereof, may be effectuated.

The method of use of the portable fluid-storage container may include the steps of introducing one or more selected fluid to a hermetically sealed body of the container, transporting the container to a desired location where the fluid may be used, conditioning the fluid, and dispensing the fluid for use. The conditioning step may include one or more of filtering the fluid, re-circulating the fluid, and mixing the fluid, whereby desired properties of the fluid may be achieved. The dispensing and or the conditioning steps may be carried out using an integrated prime mover, whereby contamination may be avoided, and whereby the prime mover may be adapted for optimal performance characteristics based on one or more characteristic of the selected fluid. Furthermore, the step of transporting may include carriage of the container via a fork-lift, a cable, a chain, or the like, and may include stacking and/or leveling.

Accordingly, one feature and advantage of the present invention is its ability to facilitate storage and dispensing of a selected fluid at a desired location with decreased reliance on separate equipment, with decreased costs, and decreased risk of contamination and/or personal injury.

Another feature and advantage of the present invention is its ability to filter the fluid before dispensing via one or more integral filtration device, and to selectively condition the fluid via re-circulation, such as through the one or more filter.

Yet another feature and advantage of the present invention is its ability to mix the fluid, or two or more components thereof, to achieve a desired composition, formulation, viscosity, purity, or other characteristic of the fluid upon dispensing.

These and other features and advantages of the present invention will become more apparent to those ordinarily skilled in the art after reading the following Detailed Description of the Invention and Claims in light of the accompanying drawing Figures.

### BRIEF DESCRIPTION OF THE DRAWINGS

Accordingly, the present invention will be understood best through consideration of, and with reference to, the following drawing Figures, viewed in conjunction with the Detailed Description of the Invention referring thereto, in which like reference numbers throughout the various Figures designate like structure, and in which:

FIG. 1 is a perspective view of a portable fluid-storage container according the preferred embodiment of the present invention;

FIG. 2 is front partial cutaway view of the portable fluid-storage container of FIG. 1; and

FIG. 3 is a perspective view of a plurality of portable fluid-storage containers arranged at a desired location.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the present invention illustrated in the Figures, specific terminology is employed for the sake of clarity. The invention, however, is not intended to be limited to the specific terminology so selected, and it is to be understood that each specific element includes all technical equivalents that operate in a similar manner to accomplish a similar purpose.

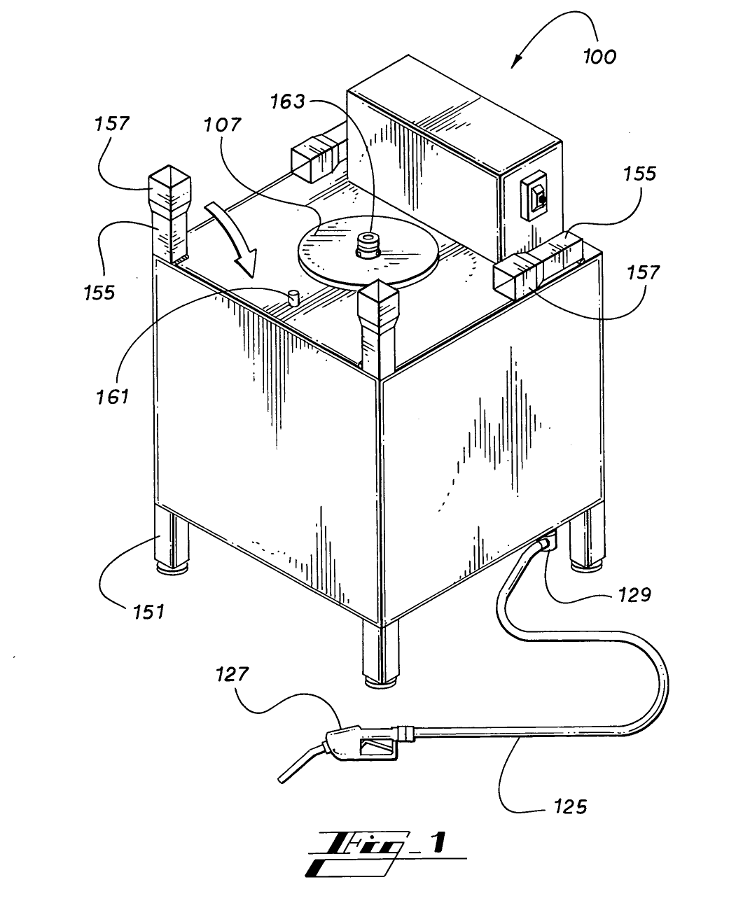

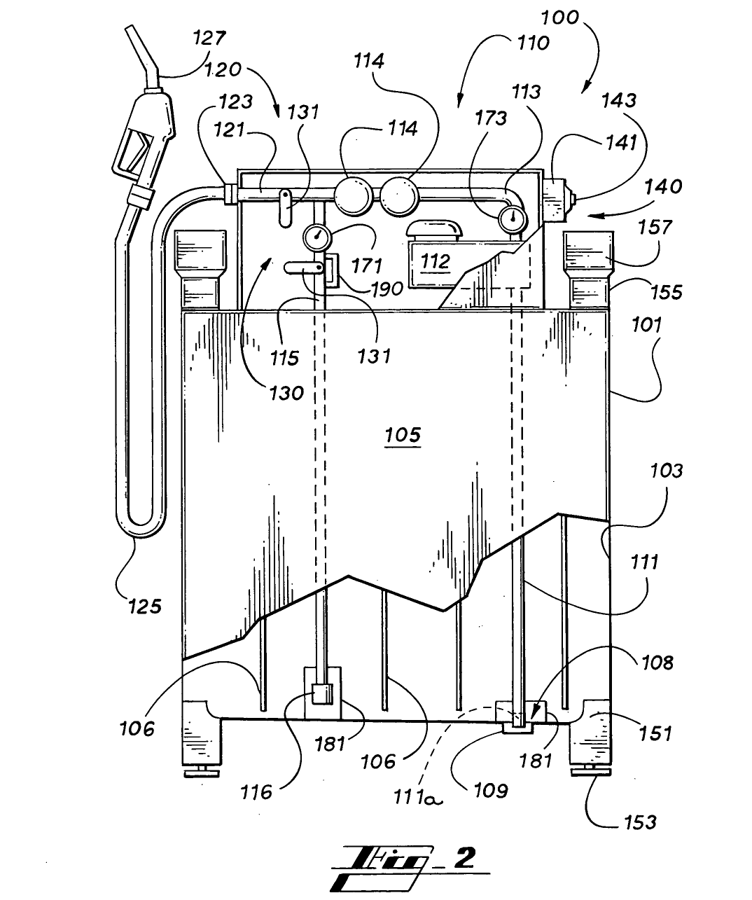

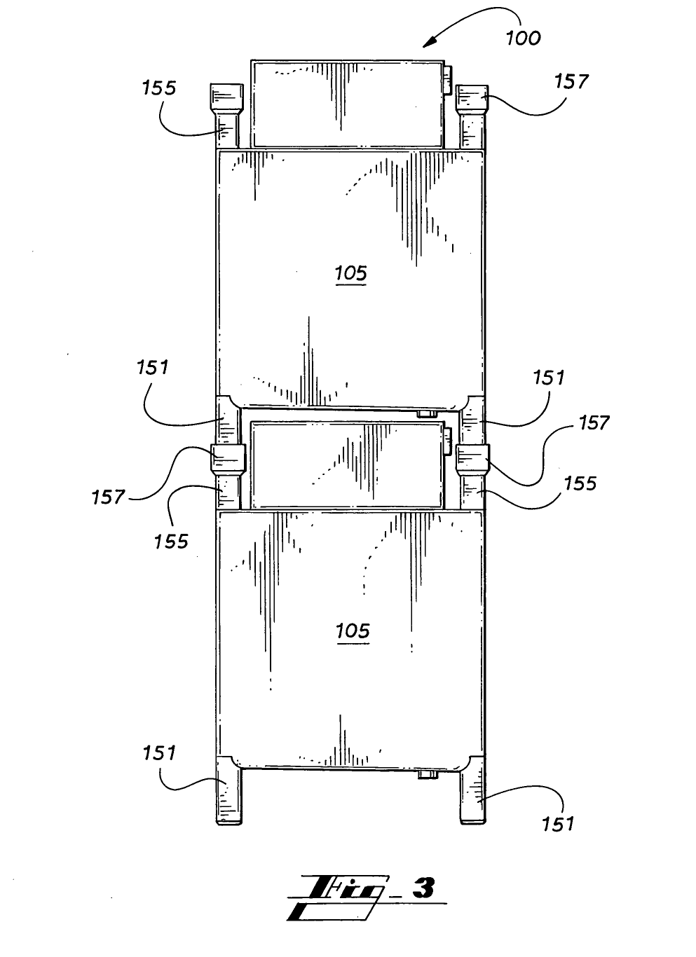

In that form of the preferred embodiment of the present invention chosen for purposes of illustration, FIGS. 1-3 show portable fluid-storage container 100 for storing, conditioning, and dispensing a selected fluid, including conditioning system 110 and dispensing system 120.

Portable fluid-storage container 100 may comprise housing 101 formed of a durable and resilient material, such as steel or other metal, a high density plastic material, natural or synthetic rubber, combinations thereof, or the like, having interior surface 103 defining hermetically sealable enclosed space 105 therein for containing the fluid. Housing 101 is shown as having generally rectangular cross-sections, although other cross-sectional configurations, such as circular, among others, may be utilized. Housing 101 preferably protects hermetically sealable enclosed space 105 and any components disposed therein from damage, and preferably provides structure to support any weight disposed thereon, including the weight of one or more additional components, or the weight of additional storage containers stacked thereon. Housing 101 may include one or more door(s), panel(s), or other access means, including seals and/or locks, to enable inspection, maintenance, repair, and/or replacement of the components disposed therein.

Interior surface 103 may comprise an inner surface of a wall or side of housing 101, or may alternatively comprise an inner surface of a rigid or flexible liner of housing 101 that is capable of containing the fluid therein. Thus, interior surface 103 is preferably impermeable to the fluid, and is preferably inert, whereby the fluid may not be contaminated or degraded by contact with interior surface 103, and whereby interior surface 103 may not be eroded or degraded by the fluid. Thus, interior surface 103 is capable of containing the fluid for prolonged periods of time without substantial adverse change to either the fluid or to interior surface 103. Interior surface 103 may be configured as desired to define a predetermined volume therein, such as a volume of 350 gallons or less, or the like, whereby additional spill-containment means may not be required by applicable governing authorities. Interior surface 103 may further be configured to include one or more contour feature(s) such as well or sump 109, or a slope or other drainage means. Interior surface 103 may additionally or alternatively include one or more baffle 106 or other flow control means, whereby flow may be selectively impeded, directed, or the like. Preferably, a bottom of interior surface 103 is configured having a slope toward collection area 108, whether formed as well or sump 109, or as a local depression, or the like.

Housing 101 and interior surface 103 preferably each include access means 107 formed therein selectively operable to provide access to, and to hermetically seal, hermetically sealable enclosed space 105. Access means 107 may be formed as a hatch, including one or more locking means and one or more sealing bushing(s), ring(s), gasket(s), or the like, whereby access to one or more component(s) disposed within hermetically sealable enclosed space 105 may be accessed, such as for installation, inspection, repair, or replacement thereof, or for introduction of a fluid thereinto. Housing 101 and interior surface 103 may additionally include pressure-relief means 161 to allow vapors or other gas to escape hermetically sealable interior space 105, whereby unsafe interior pressures may be avoided, while preventing infiltration of contaminants, moisture, or the like. Similarly, one or more access port 163, such as a bung or an opening having a flexible sealing bushing therein, may be provided to allow introduction of the fluid, or a probe, into hermetically sealable interior space 105, while preventing leakage or the like, such as to enable selective introduction or measurement of one or more characteristic of the fluid, or the like. Access port 163 may include a quick connect coupling fitting and a sealing cap engaged therewith, whereby the sealing cap may quickly and easily be removed to allow filling, or the like. As will be understood by those ordinarily skilled in the art, locks or other security or tamper-resistant devices may be used in conjunction with access port 163 and/or access means 107.

Conditioning system 110 may be operable with hermetically sealable enclosed space 105 to alter or maintain one or more characteristic(s) of the fluid. Preferably, conditioning system 110 may include prime mover 112, such as a pump, in communication with the fluid disposed within hermetically sealable enclosed space 105, such as via first conduit 111. First conduit 111 may engage prime mover 112 at a first end and have a second end disposed proximate well or sump 109 formed in interior surface 103, whereby fluid may collect therearound for movement under a force generated by prime mover 112. First conduit 111 preferably includes one-way valve 111a proximate the second end whereby fluid may not exit therefrom, such as under the force of gravity, whereby priming of pump 112 may be avoided even after long periods of inactivity. First conduit 111 may further include stabilization or vibration reducing means 181 The fluid may be moved, such as by prime mover 112, through second conduit 113 to one or more filter 114, whereby water, oil, particulate matter, chemicals, or other contaminants may be removed to purify the fluid.

Filter 114 may be selected to achieve a desired amount of filtration, i.e. to remove a desired amount of contaminants, during a first passage of the fluid therethrough, in which case the fluid may be dispensed after a single passage through filter 114, as described in greater detail below. Alternatively, however, repeated passage of the fluid through filter 114 may be desired or required in order to achieve or maintain a desired purity level, or the like, before dispensing. When repeated filtration is desired or required, flow control means 130, such as one or more operable valve 131 may selectively be actuated to prevent flow of the fluid through third conduit 121 to outlet port 123 and to permit flow through fourth conduit 115, whereby the fluid may be returned to hermetically sealable enclosed space 105 via re-circulation.

Fourth conduit 115 may, optionally, include mixing means 116 operable therewith to create turbulence or other flow tending to mix the fluid disposed in hermetically sealable enclosed space 105. Mixing means 116 is preferably formed as a static mixer including one or more nozzle or other fluid outlet, and/or one or more baffle or other deflection member, whereby fluid flow through fourth conduit 115 is directed by mixing means 116 to create turbulence within hermetically sealable enclosed space 105. Alternatively, mixing means 116 may be formed as a dynamic mixer, such as a propeller, a stirring device, or the like. Furthermore, mixing means 116 may be formed as an in-line static mixer, whereby mixing may be accomplished within fourth conduit 115.

Dispensing is preferably accomplished by permitting fluid flow through third conduit 121 to outlet port 123, whereby fluid may be dispensed at a desired location via hose 125 and nozzle 127. Nozzle 127, hose 125, or any connection thereof, may include a one-way valve or sealing means for allowing fluid to flow in a selected direction while preventing back-flow of the fluid and/or introduction of foreign matter or contaminants. Such sealing means may be biased, such as via one or more spring or other resilient member, whereby nozzle 127, or another port, is automatically sealed when fluid is not dispensed therefrom or flowing therethrough.

Preferably, controller 140 selectively prevents or permits flow through third conduit 121 and fourth conduit 116, by transmitting control signals to flow control means 130, whereby dispensing may be accomplished only when a value of one or more parameter or characteristic of the fluid is substantially equal to a predetermined value, and whereby fluid conditioning may be performed to adjust the parameter or characteristic to the predetermined value. Such control may be enabled by one or more sensor operable to sense a value of the one or more parameter or characteristic and means for comparing the sensed value to the predetermined value, wherein control signals are generated based on the comparison to control one or more of flow control means 130 and pump 112.

For example, a composition of the fluid may be sensed, either directly or indirectly, as the fluid flows through one or more of first conduit 111 or second conduit 113, to determine if the composition matches a predetermined composition. If the sensed composition does not substantially equal the predetermined composition, controller 140 may initiate a mixing operation, as described above, until the sensed composition substantially equals the predetermined composition. Additionally, one or more flow sensor(s), such as an in-line sensor, a non-contact sensor, or the like, may be associated with one or more of first conduit 111, second conduit 113, third conduit 121, and/or fourth conduit 115, whereby flow rates, volumes, or the like, may be determined and displayed to a user, or used as the basis for a control signal to selectively prevent or permit flow within portable fluid-storage container 100.

Alternatively, however, manual control may be exercised over one or more of the conditioning functions, i.e. filtering, re-circulating, and/or mixing, among others. For example, a user may manually close valve 131 associated with third conduit 121, open valve 131 associated with fourth conduit 115, and initiate pump 112, such as via button 143 of control panel 141, to re-circulate the fluid through filter 114 and/or mixing means 116. In such alternative configuration including manual control, one or more flow sensor(s) may nonetheless be included, whereby metering of a dispensed fluid, a recirculated fluid, or the like, may be enabled.

Additionally, one or more bypass conduit may be included, including associated flow control means, whereby flow may be diverted around one or more of filter 114, mixing means 116, a sensor, or the like, in order to provide greater control over the conditioning of the fluid. For example, bypass conduit 190 may be included whereby fluid may flow past valve 131 when valve 131 is closed, at least when a pressure in second conduit 113 exceeds a predetermined threshold. Accordingly, bypass conduit 190 may include a pressure relief valve set to prevent flow through bypass conduit 190 when pressure in second conduit 113 is below the predetermined threshold. Additionally, bypass conduit 190 may optionally include an air valve, whereby trapped air or other gas may be released.

Furthermore, one or more additional conditioning device(s), such as a desiccant, an oxygen-reducing agent, an air-absorbing agent, a water-reducing agent, an air filter, a heating and/or cooling device, or the like, may be provided, operable with hermetically sealable enclosed space 105. Such device(s) may be mounted within enclosed space 105 or may be carried on an exterior of housing 101 and operable with enclosed space 105, as with pressure relief means 161. Accordingly, conditioning of hermetically sealable enclosed space 105, and/or the fluid therein, may be accomplished independently of the operation of prime mover 112, whereby energy may be conserved, and the condition of the fluid may be maintained or controlled at times or locations a power supply for prime mover 112 is unavailable.

Since portable fluid-storage container 100 is adapted for use in remote or undeveloped areas, further considerations for energy conservation or supply may be made, in addition to a retractable power cord for supply of electrical power via a conventional outlet. For example, one or more battery or other stored electrical power supply(ies) may be included for use as a primary or secondary power supply for prime mover 112, controller 141, and/or operable flow control means, or the like. Similarly, prime mover 112 may be powered by a source of compressed air or other fluid, such as via an internal or compressed fluid tank, with or without on-board compressing means. Alternatively, portable fluid-storage container 100 may include an integrated fuel supply, such as a container of gasoline, diesel, or the like. When portable fluid-storage container 100 is used to store and dispense such a combustible fluid, prime mover 112 (appropriately rated and explosion-proofed) may be powered directly by the fluid, or indirectly thereby, such as via a generator. Finally, prime mover 112 may be hand operated such that reliance on a supply of electricity and/or fuel may be reduced. Additionally, an additional outlet port 129 may be provided, such as operable with collection area 108 of interior surface 103, whereby the fluid may be dispensed through outlet port 129, and through hose 125 and/or nozzle 127, via gravity.

Thus, housing 101 may include feet 151 to provide clearance for outlet port 129, hose 125, and/or nozzle 127 to facilitate dispensing. Feet 151 may further include independent leveling means 153 to allow portable fluid-storage container 100 to be stored in an upright orientation, whereby fluid therewithin may collect at a desired location, such as proximate the open end of first conduit 111. Additionally, posts 155 and/or receivers 157 may be provided to securely engage the feet 151 of a second portable fluid-storage container 100, such as via a locking mechanism, whereby the second portable fluid-storage container 100 may be supported by housing 101 of the first. Additionally or alternatively, one or more separate spacer may be utilized to provide adequate clearance to enable such stacking feature.

In such a stacked arrangement, feet 151 of a second portable fluid-storage container 100 and posts 155 of the first preferably cooperate to provide sufficient clearance for components, such as prime mover 112, filter 115, flow control means 130, controller 140, or the like, as well as for access to hermetically sealable enclosed space 105 via access means 107. When not in use, posts 155 preferably may be collapsed, retracted, or the like, whereby they are disposed out of the way in a convenient configuration. Posts 155 may further include means for engaging one or more hook, clip, ring, chain, or the like of a hoisting or lifting means, whereby portable fluid-storage container 100 may conveniently be transported on a variety of machinery, such as those likely to be found at the location.

In use, a fluid, such as a lubricant, a combustible fluid, a sealant, a food item or ingredient, a pharmaceutical, or the like, may be introduced into hermetically sealable enclosed space 105 of portable fluid-storage container 100, such as via access means 107, an input or filling port, such as access port 163, output port 123 and/or 129, or the like, at a facility for manufacture, distribution, or processing of the fluid. One or more conditioning device(s) or other component(s) may be installed or adjusted at the time of filling, or may be pre-installed or pre-adjusted, based on the selection of the fluid, whereby portable fluid-storage container 100 is specially adapted for containment, storage, transportation, conditioning, and/or dispensing of the selected fluid.

Portable fluid-storage container 100 may then be transported to a desired location where the fluid is needed, such as via truck, plane, shipping container, or other conventional transportation means. In many instances, it may be beneficial to stack two or more portable fluid-storage containers 100 to improve space-efficiency, and reduce incremental transportation costs. To facilitate such transportation, portable fluid-storage container 100 may be manipulated using a forklift via disposing the forks between feet 151. Outlet port 129 is preferably protected during such manipulation by virtue of its placement between two feet 151. Alternatively, transportation of portable fluid-storage container 100 may be accomplished via suspension from a crane or hoist, such as through engagement of posts 155 with a hook or other engagement means of the crane or hoist.

Upon delivery at the desired location, portable fluid-storage container 100 may be situated as desired for use in selectively conditioning and/or dispensing the fluid. For example, when a machine at the desired location needs lubrication, portable fluid-storage container 100 may be operated to filter, re-circulate, and/or mix a lubricant contained therein until a desired characteristic is substantially achieved, whereafter the lubricant may be dispensed to lubricate one or more components of the machine.

Alternatively, portable fluid-storage container 100 may be transported to a desired location without any fluid therein, whereby portable fluid-storage container 100 may be used as an on-site mixer of two of more fluids, such as via operable association with two or more portable fluid-storage containers 100 separately containing respective fluids, thereby enabling mixtures to be produced as needed in batches of a desired size, according to a desired composition, formulation, viscosity, purity, or the like. Furthermore, the mixtures may be simultaneously or subsequently conditioned, such as via filtration or the like. Such use of portable fluid-storage container 100 as an on-site mixer may be especially beneficial when storage and/or transportation of the desired mixture is problematic, such as when the two or more fluids of the mixture are chemically reactive, volatile, explosive, unstable or the like.

Similarly, when portable fluid-storage container 100 is delivered in an empty state, it may be used as a temporary holding reservoir, such as during repair of a machine or component. In such a use, a fluid may be evacuated from the machine or component and transferred into portable fluid-storage container 100 during such repair. The fluid may selectively be circulated, conditioned, treated, or the like, and may subsequently be replaced in the machine or component when desired, such as when repairs have been completed.

Having thus described exemplary embodiments of the present invention, it should be noted by those skilled in the art that the within disclosures are exemplary only and-that various other alternatives, adaptations, and modifications may be made within the scope and spirit of the present invention. For example, one or more conventional feature, such as a fill gauge or other fluid indicator may be included to convey information pertaining to a status, quantity, or other characteristic of a fluid stored within portable fluid-storage container 100. Likewise, one or more securing caps or connectors, such as quick-connect fittings or couplings, may be utilized at one or more connection or nozzle, whereby such connection(s)/nozzle(s) may be locked or secured against tampering or accidental introduction or release of material. Accordingly, the present invention is not limited to the specific embodiments as illustrated herein, but is only limited by the following claims.

What is claimed is at least:

1. A fluid container comprising:
a body having a hermetically sealable interior space for containing a fluid;
at least one port operable to selectively allow access to said hermetically sealable interior space;
a prime mover for dispensing the fluid from said hermetically sealable interior space via said at least one port; and
at least one conditioning device operable with said prime mover to adjust at least one characteristic of the fluid.

2. The fluid container of claim 1, wherein said at least one prime mover comprises a pump operable to move the fluid through said at least one port via a conduit.

3. The fluid container of claim 2, wherein said at least one conditioning device comprises at least one filter operable with said conduit to filter the fluid flowing therethrough.

4. The fluid container of claim 3, further comprising flow control means for preventing fluid flow to said at least one port from said at least one filter, and a re-circulation conduit operable to direct the flow to said hermetically sealed interior space.

5. The fluid container of claim 2, wherein said conduit comprises a re-circulation conduit operable with said pump to re-circulate the fluid, and wherein said at least one conditioning device comprises turbulence creation means operable with said re-circulation conduit to mix the fluid within said hermetically sealed interior space.

6. The fluid container of claim 5, wherein said turbulence creation means comprises a static mixer operable with said re-circulation conduit.

7. The fluid container of claim 1, further comprising a housing, said housing being at least one of modular and stackable.

8. The fluid container of claim 7, wherein said housing comprises engagement means for engaging at least one of a fork-lift, a crane, and a hoist.

9. A fluid container comprising:
a pump for dispensing a fluid stored in said fluid container; and
a fluid conditioning system operable with said pump,
wherein said fluid conditioning system is operable to filter said fluid, re-circulate said fluid, and mix said fluid.

10. The fluid container of claim 9, further comprising flow control means for selectively permitting and preventing flow through a return conduit and an output conduit.

11. The fluid container of claim 10, wherein said flow control means prevents flow through said output conduit and permits flow through said return conduit during at least one of re-circulation and mixing.

12. A method of use of a portable fluid-storage container, comprising the steps of:
transporting the storage container to a desired location;
conditioning the fluid within the storage container; and
dispensing the fluid from the storage container via a pump therein.

13. The method of claim 12, wherein said step of conditioning comprises the step of filtering.

14. The method of claim 13, wherein said step of filtering comprises pumping the fluid through at least one filter before said step of dispensing.

15. The method of claim 12, wherein said step of conditioning comprises the step of pumping the fluid through at least one filter and through a return conduit, whereby the fluid is re-circulated within the storage container.

16. The method of claim 15, wherein said step of conditioning further comprises preventing flow through an outlet port of the storage container and permitting flow through the return conduit.

17. The method of claim 16, wherein said step of dispensing comprises permitting flow through the outlet port of the storage container and preventing flow through the return conduit.

18. The method of claim 12, wherein said step of condition comprises the step of mixing the fluid within the storage container.

19. The method of claim 18, wherein said step of mixing comprises pumping the fluid through a return conduit and a static mixer disposed beneath a surface of the fluid.

20. The method of claim 12, wherein said step of conditioning comprises the steps of determining a characteristic of the fluid, and comparing the determined characteristic with a predetermined characteristic.
